(19) United States
(12) Patent Application Publication
(10) Pub. No.: US 2005/0226395 A1
(43) Pub. Date: Oct. 13, 2005

(54) Network support for consensual mobile recording

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/818,397

(22) Filed: Apr. 5, 2004

(51) Int. Cl. H04M 1/64

(52) U.S. Cl. 379/85; 379/67.1

(57) ABSTRACT

Embodiments of the method and system provide for providing notice and consent for recording a portion of a conversation between at least a first party and a second party. The method may have the steps of: triggering a telecommunication network to provide notice to the parties that a conversation is going to be recorded; requesting, by the network, a consent to record the conversation; effecting, if consent is not received from each of parties, no recording of the conversation; recording, if consent is received from each of parties, the conversation until the one of the parties triggers the telecommunication network to cease recording the conversation; and storing the recorded conversation in the telecommunication network. The system implements the method.

### TECHNICAL FIELD

The present invention relates generally to telephony and more particularly to a method and system that provides notice and consent for recording a portion of a telephone conversation, such as a mobile terminal conversation.

### BACKGROUND OF THE INVENTION

Currently there exist various systems for automatically recording telephone calls. One of the issues that now arise in the recording of telephone calls is a concern for the privacy rights of the calling and called parties. Various state and/or federal laws require that the consent of the calling party, the called party, or both, be obtained in order to record or monitor a telephone call. This requirement pertains regardless of whether the telephone call is placed and recorded between two private telephones, or in a sophisticated integrated telephone call recording system.

Frequently, when driving, for example, it is not convenient to write down information or perform data entry. Often in such situations, mobile subscribers want to be able to use their mobile handset as a recording device during a call to leave themselves a “voice memo” for later retrieval. In order to perform a legal recording of a conversation, the parties to a conversation must have knowledge that a recording will be made and must consent to the recording.

Thus, it is a drawback of the prior art that there does not exist a method and apparatus that provides notice and consent for recording a portion of a telephone conversation, such as a mobile terminal conversation.

### SUMMARY

The invention in one implementation encompasses an apparatus. The apparatus may be for use in a telecommunications network for providing notice and consent for recording at least a portion of a conversation between at least a first mobile caller and a second caller. The apparatus has: a telecommunication network operatively connected to a mobile terminal of a first caller and a terminal of a second caller; the telecommunication network having a call controller, a subscriber database, and a voice messaging system; the voice messaging system having controller module operatively connected to an announcing module and to a recording module, the controller module operatively connected to the call controller, and the recording module operatively connected to the subscriber database; and recorded messages between the at least first mobile caller and the second caller being stored in the subscriber database; wherein the telecommunication network provides notice to the parties that a conversation between the parties is going to be recorded, wherein the network obtains consent of the parties to record the conversation between the parties, wherein the conversation is recorded until one of the parties triggers the telecommunication network to cease recording the conversation, and wherein the recorded conversation is stored in the telecommunication network.

Another implementation of the invention encompasses a method. The method may be used in a telecommunications network for providing notice and consent for recording a portion of a conversation between at least a first caller and a second caller. The method may have the steps of: triggering, via one of the at least first and second parties, a telecommunication network to provide notice to at least one other of the first and second parties that a conversation between at least the first and second parties is going to be recorded; requesting, by the network, a consent by the other of the first and second parties to record the conversation between the parties; effecting, if no consent is received from the other of the first and second parties, no recording of the conversation; recording, if consent is received from the other of the first and second parties, the conversation until the one of the at least first and second parties triggers the telecommunication network to cease recording the conversation; and storing the recorded conversation in the telecommunication network.

### BRIEF DESCRIPTION OF THE DRAWINGS

Features of exemplary implementations of the invention will become apparent from the description, the claims, and the accompanying drawings in which:

FIG. 1 depicts a block diagram illustrative of a mobile switching center, base station and mobile terminal for use with the present method and system.

FIG. 2 illustrates a more detailed block diagram illustrative of a mobile switching center, base station, and mobile terminal according to one embodiment of the present method and system.

FIG. 3 illustrates a very general flow chart of logical operational steps that may be followed in accordance with one embodiment of the present method and system.

FIG. 4 illustrates another flow chart of logical operational steps that may be followed in accordance with one embodiment of the present method and system.

FIG. 5 illustrates another flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Embodiments of the present apparatus and method provide for a telephone or telecommunication network to support recording capabilities from a mobile terminal (such as a cell phone, mobile phone, mobile handset, etc.) while the mobile handset is active on a call. Either the called party or the calling party may initiate this feature. In order to ensure the legality of this recording, an announcement may be played from the network prior to actually recording a conversation. The party initiating the recording must first receive consent to record from the other party or parties. A party may indicate their consent to record by pressing an appropriate key on their mobile terminal or by having them give a voice reply, such as “yes” or “agree”.

One advantage of the present apparatus and method is that mobile subscribers, who are driving a vehicle, can “record” the output of a directory assistance query, driving directions to a particular location, reminders, and the like, during a current phone conversation. The result of the recording may be stored in the network for the initiating mobile subscriber to retrieve at a later time. Furthermore, a copy of the recorded conversation may be forwarded to the other party to the conversation.

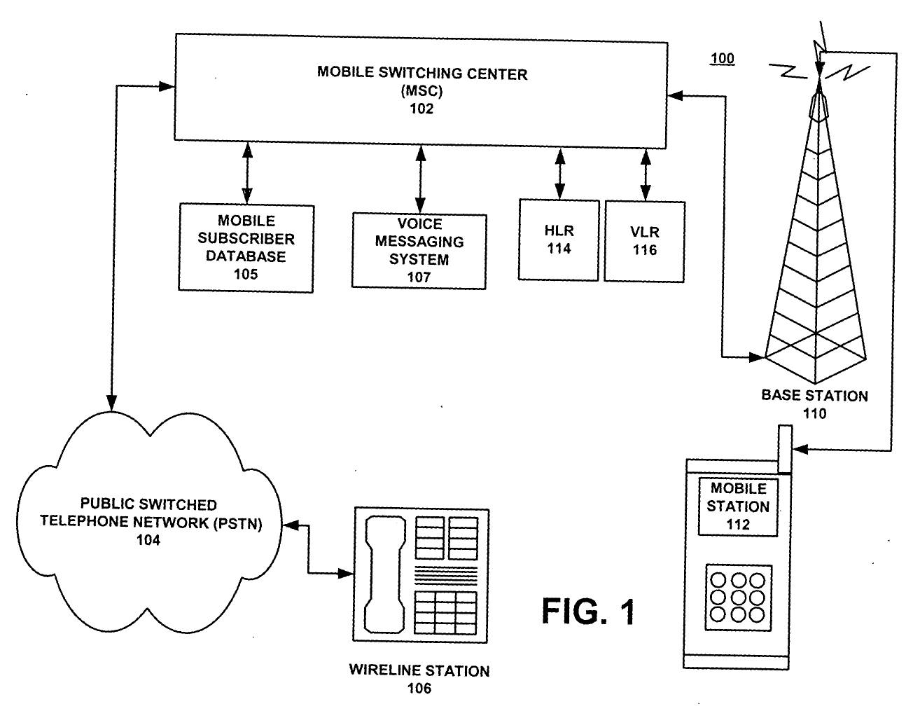

The present method and system may be used with wireless, as well as, wired telecommunication networks. Turning to FIG. 1, an apparatus 100 in one example may have a telecommunication network 100. At least one mobile terminal 112 of a plurality of mobile terminals may be operatively connected to the telecommunication network 100. Although the present system and method may be used with any type of network (wired and wireless, for example), the subscriber may typically be a mobile subscriber who uses a mobile terminal (also referred to as mobile phone, a cell phone, mobile handset, or car phone).

As depicted in the FIG. 1 embodiment, the network (or telecommunication network) 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 is connected to the MSC 102. The PSTN 104 routes calls to and from mobile users through the MSC 102. The PSTN 104 also routes calls from and to wireline stations 106. The MSC 102 may also be connected to one or more base stations (BS) 110. Each of the base stations 110 communicates with mobile terminal(s) 112 in its service area. The PSTN 104 generally may be implemented as the worldwide voice telephone network accessible to all those with telephones and access privileges (e.g., AT&T long distance network).

Each of the mobile terminals 112 may have a home location register (HLR) 114 where data about each of the mobile terminals 112 resides. Some of the mobile terminals 112 may be remotely located from their home location, and in that case, a visiting location register (VLR) 116 may be set up locally for each mobile terminal 112 that is visiting in its service area. HLR 114 may be implemented as a permanent SS7 database utilized in cellular networks, such as, but not limited to, for example, AMPS (Advanced Mobile Phone System), GSM (Global System for Mobile Communications), and PCS.

HLR 114 may be utilized generally to identify/verify a subscriber, and also may contain subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, may be implemented as a local database maintained by the cellular provider whose territory is being roamed. Mobile terminal 112 may be implemented as a cellular device, personal communication device, short message service device or wireless communications device (e.g., a wireless personal digital assistant).

The MCS 102 may have, or be operatively connected to, components of a system for providing a voice messaging feature. Such components in some embodiments may include voice messaging system 107 and mobile subscriber data 105.

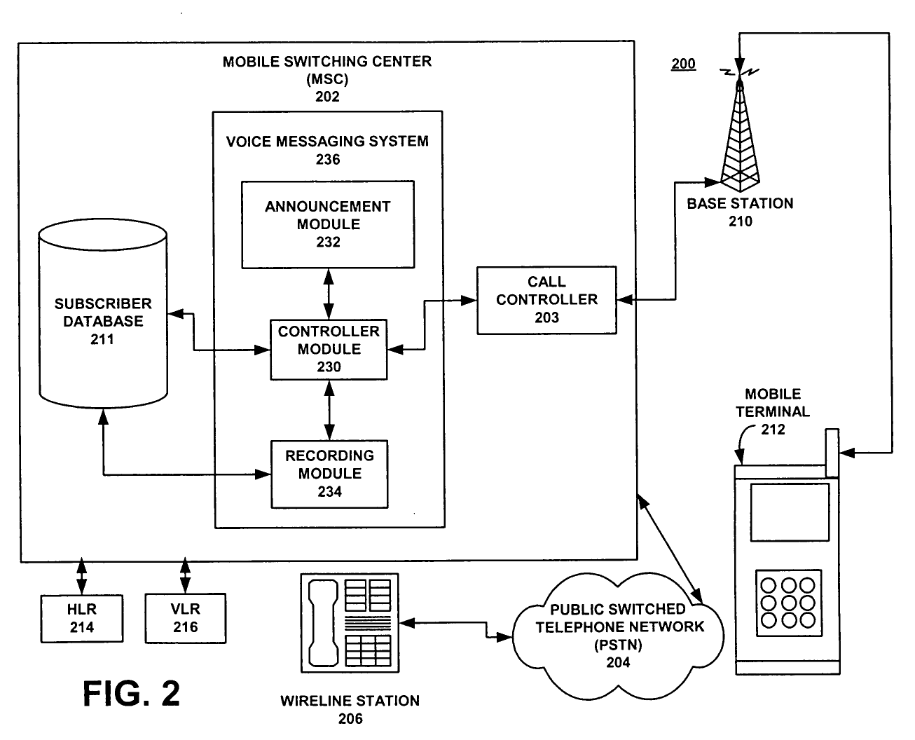

Referring to FIG. 2, a network (or telecommunication network) 200 is shown for at least one mobile terminal 212 of a plurality of mobile terminals operatively connected to the telecommunication network 200. The network 200 has a mobile switching center 202, which is operatively connected to PSTN 204, base station 210, and mobile terminal 212 according to one embodiment of the present method and system. The PSTN 204 routes calls to and from mobile terminal(s) 212 through the MSC 202, and also routes calls from and to wireline stations 206. The MSC 202 may be connected to one or more base stations 210. The base station 210 communicates through the air to mobile terminal 212, which, for example, may be of a cellular telephone type or of the wider bandwidth personal communication device type. Mobile terminal 212, for example, may be a wireless handset or an automobile mounted station the same as those shown in FIG. 1. The MSC 202 is operatively connected thereto a VLR 216 and a HLR 214 that interface with the mobile terminal 212 as explained above.

The voice messaging system 236 may have a controller module 230 operatively connected to an announcing module 232 and to a recording module 234. The controller module 230 may be operatively connected to the call controller 203 for interfacing with the mobile terminal 212 and the wireline station 206. For storing recorded conversations, the recording module 234 may be operatively connected to the subscriber database 211. Also for retrieving a recorded conversation, the call controller module 230 may also be operatively connected to the subscriber database 211. The telecommunication network via the controller module 230 may provide notice to the parties that a conversation between the parties is going to be recorded, when the network obtains consent of the parties to record the conversation between the parties. The conversation may be recorded until one of the parties triggers the telecommunication network to cease recording the conversation. Announcements for call recording notification and call recording termination may be formed and/or stored in the announcement module 232.

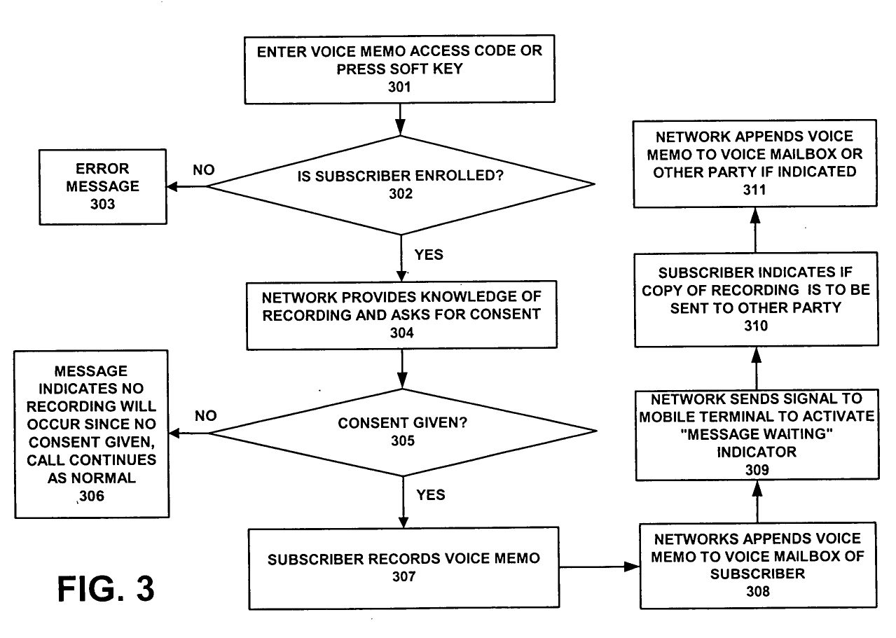

FIG. 3 is a general block diagram depicting an embodiment of the present method. The method may have the steps of: entering a voice memo access code or pressing a soft key (step 301); checking if the subscriber is enrolled (step 302); sending an error message (step 303) if the subscriber has not enrolled; if the subscriber has enrolled, network providing knowledge of recording and asking for consent (step 304); determining if the consent has been given (step 305); if consent has not been given, giving a message to indicate no recording will occur since no consent has been given, call continues as normal (step 306); if consent has been given, providing subscriber with the opportunity to record a voice memo (step 307); appending by the network the voice memo to the voice mailbox of subscriber (step 308); sending by the network signal to mobile terminal to activate “message waiting” indicator (step 309); subscriber indicating if copy of recording is to be sent to other party (step 310); and appending by the network voice memo to voice mailbox or other party if indicated (step 311).

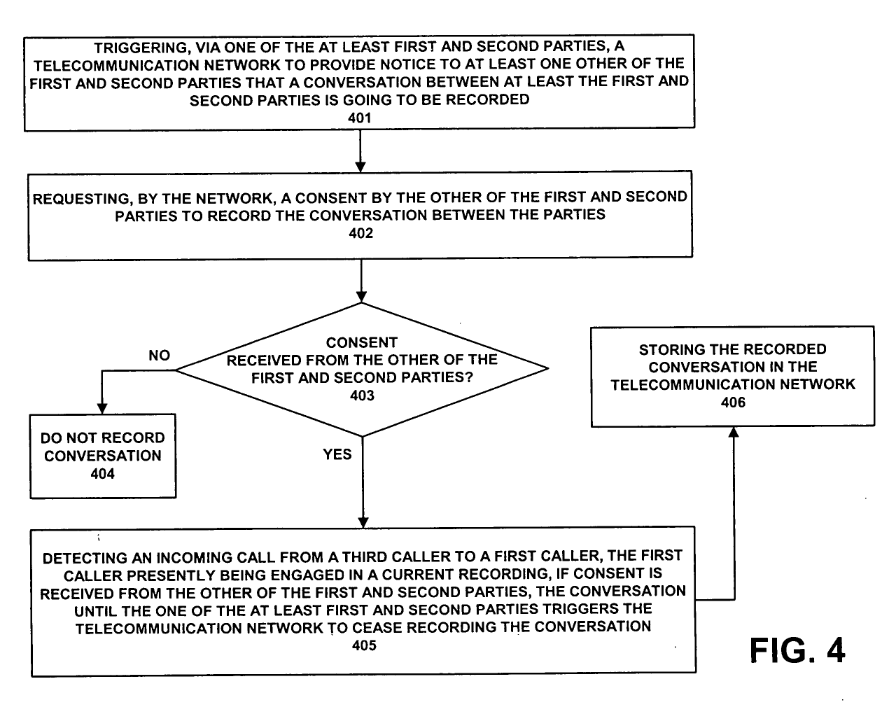

FIG. 4 is a block diagram depicting another embodiment of the present method in general terms. This embodiment of the method may have the steps of: triggering, via one of the at least first and second parties, a telecommunication network to provide notice to at least one other of the first and second parties that a conversation between at least the first and second parties is going to be recorded (step 401); requesting, by the network, a consent by the other of the first and second parties to record the conversation between the parties (step 402); determining if consent has been received from the other of the first and second parties (step 403); not recording the conversation (step 404) if consent has not been received from the other of the first and second parties; detecting an incoming call from a third caller to a first caller, the first caller presently being engaged in a current recording, if consent is received from the other of the first and second parties, the conversation until the one of the at least first and second parties triggers the telecommunication network to cease recording the conversation (step 405); storing the recorded conversation in the telecommunication network (step 406).

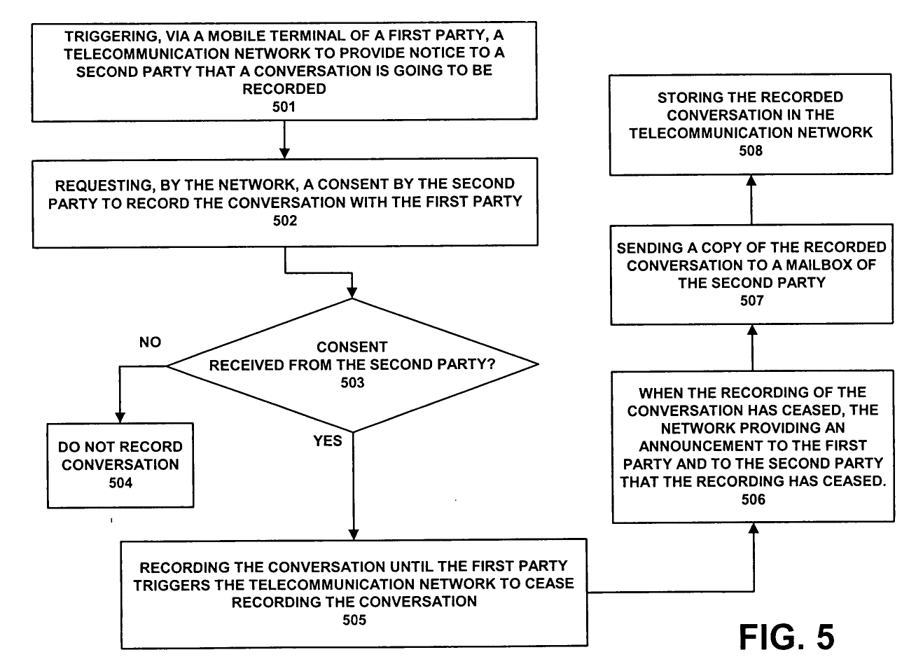

FIG. 5 is a block diagram depicting another embodiment of the present method. This embodiment of the method may have the steps of: triggering, via a mobile terminal of a first party, a telecommunication network to provide notice to a second party that a conversation is going to be recorded (step 501); requesting, by the network, a consent by the second party to record the conversation with the first party (step 502); determining if consent is received from the second party (step 503); effecting, if no consent is received from the second party, no recording of the conversation (step 504); recording, if consent is received from the second party, the conversation until the first party triggers the telecommunication network to cease recording the conversation (step 505); when the recording of the conversation has ceased, the network providing an announcement to the first party and to the second party that the recording has ceased (step 506); sending a copy of the recorded conversation to a mailbox of the second party (step 507); and storing the recorded conversation in the telecommunication network (step 508).

Therefore, the improved present method and system overcomes the drawbacks of the prior art and provides notice and consent for recording at least a portion of a telephone conversation, such as a mobile terminal conversation. Embodiments of the present method and apparatus may be used, for example, for conversations between mobile terminals, between wireline stations, and between mobile terminals and wireline stations.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method for use in a telecommunications network for providing notice and consent for recording a portion of a conversation between at least a first caller and a second caller, the method comprising the steps of:
triggering, via one of the at least first and second parties, a telecommunication network to provide notice to at least one other of the first and second parties that a conversation between at least the first and second parties is going to be recorded;
requesting, by the network, a consent by the other of the first and second parties to record the conversation between the parties;
effecting, if no consent is received from the other of the first and second parties, no recording of the conversation;
recording, if consent is received from the other of the first and second parties, the conversation until the one of the at least first and second parties triggers the telecommunication network to cease recording the conversation; and
storing the recorded conversation in the telecommunication network.

2. The method according to claim 1, wherein the triggering, via the one of the at least first and second parties to provide notice to other of the first and second parties that a conversation is going to be recorded, is one of input of an access code or activation of a soft key, and wherein the triggering via the one of the at least first and second parties, to provide notice to the other of the first and second parties that recording of the conversation has ceased, is one of input of an access code or activation of a soft key.

3. The method according to claim 1, wherein the triggering of the telecommunication via the mobile terminal of the one of the at least first and second parties is consent to record the conversation.

4. The method according to claim 1, wherein, when the recording of the conversation has ceased, the network provides an announcement to all the parties that the recording has ceased.

5. The method according to claim 1, wherein the method further comprises the step of, after the recording of the conversation has ceased, triggering, via the one of the at least first and second parties, the telecommunication network to send a copy of the recorded conversation to a mailbox of the other of the at least first and second parties.

6. A method for use in a telecommunications network for providing notice and consent for recording a portion of a mobile terminal conversation, the method comprising the steps of:
triggering, via a mobile terminal of a first party, a telecommunication network to provide notice to a second party that a conversation is going to be recorded;
requesting, by the network, a consent by the second party to record the conversation with the first party;
effecting, if no consent is received from the second party, no recording of the conversation;
recording, if consent is received from the second party, the conversation until the first party triggers the telecommunication network to cease recording the conversation; and
storing the recorded conversation in the telecommunication network.

7. The method according to claim 6, wherein the triggering, via the mobile terminal of the first party to provide notice to a second party that a conversation is going to be recorded, is one of input of an access code or activation of a soft key.

8. The method according to claim 6, wherein the triggering via the mobile terminal of the first party, to provide notice to the second party that recording of the conversation has ceased, is one of input of an access code or activation of a soft key.

9. The method according to claim 6, wherein the triggering of the telecommunication via the mobile terminal of the first party is consent to record the conversation.

10. The method according to claim 6, wherein, when the recording of the conversation has ceased, the network provides an announcement to the first party and to the second party that the recording has ceased.

11. The method according to claim 6, wherein the recorded message is stored in the network and is retrievable by the mobile terminal at a future time.

12. The method according to claim 6, wherein the method further comprises the step of, after the recording of the conversation has ceased, triggering, via the mobile terminal of the first party, the telecommunication network to send a copy of the recorded conversation to a mailbox of the second party.

13. An apparatus for use in a telecommunications network in which is provided notice and consent for recording at least a portion of a conversation between at least a first mobile caller and a second caller, the apparatus comprising:
a telecommunication network operatively connected to a mobile terminal of a first caller and a terminal of a second caller;
the telecommunication network having a call controller, a subscriber database, and a voice messaging system;
the voice messaging system having controller module operatively connected to an announcing module and to a recording module, the controller module operatively connected to the call controller, and the recording module operatively connected to the subscriber database; and
recorded messages between the at least first mobile caller and the second caller being stored in the subscriber database;
wherein the telecommunication network provides notice to the parties that a conversation between the parties is going to be recorded, wherein the network obtains consent of the parties to record the conversation between the parties, wherein the conversation is recorded until one of the parties triggers the telecommunication network to cease recording the conversation, and wherein the recorded conversation is stored in the telecommunication network.

14. The system according to claim 13, wherein triggering of the telecommunication system by the mobile terminal party to provide notice to the other party that a conversation is going to be recorded is one of input of an access code or activation of a soft key, and wherein triggering of the telecommunication by the mobile terminal party to provide notice to the other party that recording of the conversation has ceased, is one of input of an access code or activation of a soft key.

15. The system according to claim 13, wherein the recorded message is temporarily stored in the subscriber database in the telecommunications network.

16. The system according to claim 13, wherein the triggering of the telecommunication network via the mobile terminal of the first party is consent to record the conversation.

17. The system according to claim 13, wherein the recorded message is stored in the network and is retrievable by the mobile terminal at a future time.
